(19) United States
(12) Patent Application Publication
(10) Pub. No.: US 2026/0145066 A1
(43) Pub. Date: May 28, 2026

(54) ONE OR MORE NON-TRANSITORY COMPUTER-READABLE MEDIA, INFORMATION PROCESSING SYSTEM, AND COMPUTER-IMPLEMENTED METHOD

(71) Applicant: Nintendo Co., Ltd., Kyoto (JP)

(72) Inventor: Wataru HINOSHITA, Kyoto (JP)

(21) Appl. No.: 19/390,232

(22) Filed: Nov. 14, 2025

(30) Foreign Application Priority Data
Nov. 28, 2024 (JP) 2024-207241

(51) Int. Cl. A63F 13/46; A63F 13/803

(52) U.S. Cl. CPC A63F 13/46; A63F 13/803

(57) ABSTRACT

An example of an information processing system according to an exemplary embodiment performs a multiplay game where a player and another player compete against each other, acquires a first parameter that increases or decreases based on a result of the competition and a second parameter that increases from a minimum value to a maximum value in accordance with an increase in the number of competitions in the multiplay game, calculates an evaluation score at least based on a third parameter obtained by reflecting the first parameter to a degree indicated by the second parameter, and presents the evaluation score to the player.

### CROSS REFERENCE TO RELATED APPLICATION

This application claims priority to Japanese Patent Application No. 2024-207241 filed on Nov. 28, 2024, the entire contents of which are incorporated herein by reference.

### FIELD

An exemplary embodiment relates to one or more non-transitory computer-readable media, an information processing system, a computer-implemented method, and an information processing apparatus that enable the execution of a multiplay game.

### BACKGROUND AND SUMMARY

Conventionally, there is a system where the rating of a player is updated in a case where the player loses or wins a multiplay game a predetermined number of times.

There is room for improvement in providing a variety of presentation methods regarding a rating.

The exemplary embodiment discloses a novel presentation method regarding a rating.

The exemplary embodiment employs the following configurations.

### First Configuration

Instructions according to a first configuration, when executed, cause one or more processors to perform operations including: causing a player to perform a competition with another player in a multiplay game based on game processing; calculating an evaluation score for the player at least based on a third parameter obtained by reflecting a first parameter that increases or decreases based on a result of the competition to a degree indicated by a second parameter that increases from a minimum value to a maximum value in accordance with an increase in the number of competitions in the multiplay game; and presenting the evaluation score.

Based on the above, it is possible to present an evaluation score that comes close to a first parameter while gradually increasing in accordance with an increase in the number of competitions. For example, it is possible to reduce the possibility that the motivation of a player decreases even if the player loses a competition.

### Second Configuration

According to a second configuration, in the above first configuration, the first parameter may be a value greater than or equal to 0, the second parameter may be a value greater than or equal to 0, and the third parameter may be a value based on a multiplication of the first and second parameters.

Based on the above, it is possible to calculate the evaluation score by calculating a third parameter by a simple calculation.

### Third Configuration

According to a third configuration, in the above second configuration, the greater the number of competitions may be, the smaller an amount of increase in the second parameter with respect to each competition may be.

Based on the above, while the number of competitions is small, it is possible to make the amount of increase in a second parameter great. For example, the more the player performs the competition, the higher the evaluation score can be.

### Fourth Configuration

According to a fourth configuration, in the above second or third configuration, the higher a ranking in the competition may be, the greater an amount of increase in the second parameter by the competition according to the increase in the number of competitions may be.

Based on the above, the higher a ranking in the competition is, the greater a second parameter can be.

### Fifth Configuration

According to a fifth configuration, in any of the above second to fourth configurations, the operations may further include calculating the evaluation score by further adding a predetermined offset to the third parameter.

Based on the above, it is possible to prevent the evaluation score from being too low.

### Sixth Configuration

According to a sixth configuration, in any of the above first to fifth configurations, the first parameter between the first and second parameters may be acquired from a server after the competition.

Based on the above, it is possible to acquire the first parameter reflecting the result of the competition from a server.

### Seventh Configuration

According to a seventh configuration, in any of the above first to sixth configurations, the operations may further include causing the player to perform the competition in the multiplay game with the other player determined based on the first parameter.

Based on the above, it is possible to use the first parameter reflecting the result of the competition to determine an opponent, while it is possible to present the evaluation score obtained by adjusting the result of the competition to the player.

### Eighth Configuration

According to an eighth configuration, in the above fourth configuration, the operations may further include, when the competition in the multiplay game starts, at least acquiring the second parameter of the other player before the competition; after the competition in the multiplay game ends, acquiring the first parameter of the other player based on the result of the competition from a server. The information processing may further include updating the second parameter of the other player based on the second parameter acquired when the competition starts and the result of the competition, calculating an evaluation score of the other player after the competition based on the updated second parameter and the first parameter acquired from the server, and presenting the evaluation score.

Based on the above, it is possible to calculate the evaluation score of another player without acquiring the evaluation score from the other player. For example, it is possible to present the evaluation score of the other player to the player immediately after the competition.

Another configuration may be an information processing system that presents the above evaluation score, or may be a computer-implemented method, or may be an information processing apparatus.

According to the exemplary embodiment, it is possible to present an evaluation score that comes close to a first parameter while gradually increasing in accordance with an increase in the number of competitions.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting diagram showing an example of the relationship between a “reflection ratio” and the number of executions of the game;

FIG. 4 is an example non-limiting diagram showing examples of the relationships between RawRate of players that differ in ability and the number of executions of the game;

FIG. 5 is an example non-limiting diagram showing examples of the relationships between evaluation scores of the players that differ in ability and the number of executions of the game;

FIG. 6 is an example non-limiting diagram showing an example of a game image displayed on a screen of a game system 1a corresponding to a player A before a multiplay racing game starts;

FIG. 7 is an example non-limiting diagram showing an example of an image displayed on the screen of the game system 1a and is an example non-limiting diagram showing an example of a game image displayed during the execution of the multiplay racing game;

FIG. 8 is an example non-limiting diagram showing an example of a game image when a player object PA reaches a goal, and the ranking of the player object PA is displayed;

FIG. 9 is an example non-limiting diagram showing an example of an image displayed on the screen of the game system 1a and is an example non-limiting diagram showing an example of a result display image displayed after the multiplay racing game ends;

FIG. 10 is an example non-limiting diagram showing examples of various pieces of data stored in a game system 1;

FIG. 11 is an example non-limiting flow chart showing an example of game processing performed by the game system 1;

FIG. 12 is an example non-limiting flow chart showing the details of a during-running process in step S103;

FIG. 13 is an example non-limiting flow chart showing the details of a result display process in step S106; and

FIG. 14 is an example non-limiting flow chart showing an example of the server process performed by a server.

### DETAILED DESCRIPTION OF NON-LIMITING EXAMPLE EMBODIMENTS

### Game System Configuration

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of direction buttons 30 including an up button, a down button, a right button, and a left button, a plurality of buttons (an A-button, a B-button, an X-button, a Y-button, an L-button, an R-button, and the like), a left analog stick 31, and a right analog stick 35 as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a “controller”.

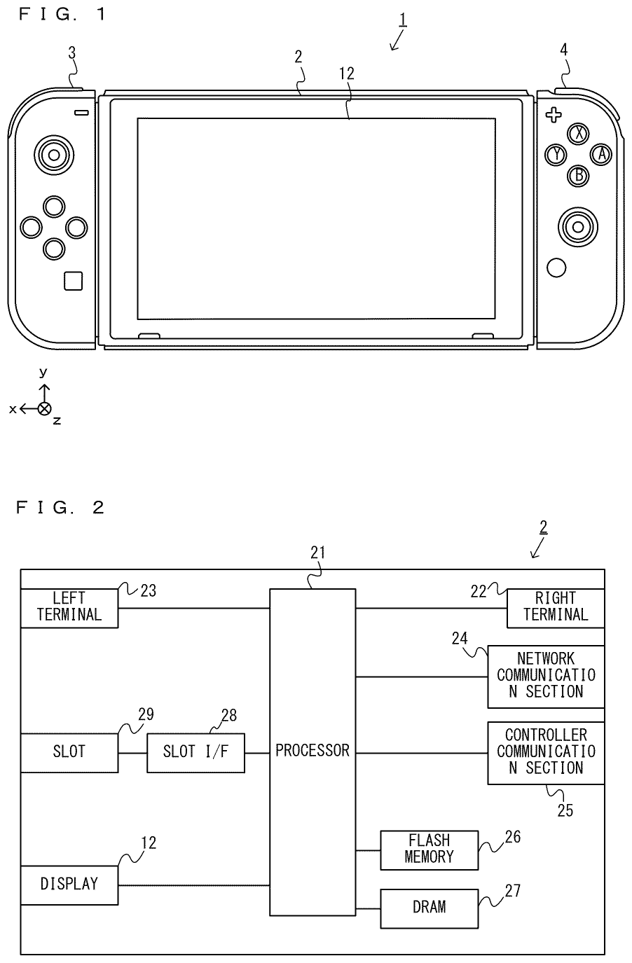

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as “I/F”) 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### Display of Ratings in Multiplay Game

In the exemplary embodiment, a competition type multiplay game in which a plurality of players participate is performed using game systems 1. For example, the multiplay game according to the exemplary embodiment may be any game, e.g., a racing game, a fighting game, a shooting game, a game such as chess, shogi, or the like, a card game, a quiz game, or the like. In the exemplary embodiment, a multiplay racing game is performed where players move player objects corresponding to the players themselves in a virtual space.

A plurality of players connect game systems 1 of the respective players to a network (e.g., the Internet) and perform the multiplay racing game. For example, the multiplay racing game according to the exemplary embodiment is performed by up to 24 players. Specifically, in accordance with an instruction from each player, the game system 1 corresponding to the player transmits a participation request to participate in the multiplay racing game to a server on the Internet. The server receives the participation requests from the plurality of game systems 1 and matches a plurality of players. If the server matches the plurality of players, the multiplay racing game by the plurality of matched players is performed. If the number of players participating in the multiplay racing game is less than 24, the multiplay racing game is performed by less than 24 players. In this case, non-player objects controlled by the processor 21 may participate in the multiplay racing game, and the racing game may be performed by 24 objects obtained by combining the player objects and the non-player objects. Here, the player objects and the non-player objects participating in the multiplay racing game are collectively referred to as “participating objects”.

In accordance with the result of the multiplay racing game, each player is evaluated (rated). As a method for evaluating the player, a predetermined rating method is used. For example, as the predetermined rating method, an Elo rating, a Glicko rating, a Glicko2 rating, or the like may be used. The predetermined rating method may be any other method.

In the predetermined rating method, a rating value is set for the player based on the result of the multiplay racing game. The rating value is a value reflecting the ability of the player in the game. A high rating value is set for a relatively strong player, and a low rating value is set for a relatively weak player.

If each player performs the multiplay racing game a sufficient number of times, the rating value of the player complies with a normal distribution centered on a predetermined value. A predetermined value is set as the initial value of the rating value of a player who has never executed the multiplay racing game. If a player executes the multiplay racing game, the rating value changes. If a player executes the multiplay racing game a sufficient number of times, the rating value of the player converges to a value according to the ability of the player. Regarding about half of the players, the more each player executes the multiplay racing game, the smaller the rating value is compared to the initial value. Thus, there is a possibility that the motivation of a player decreases.

Accordingly, in the exemplary embodiment, a rating value calculated by the predetermined rating method is set as a raw rating value, an evaluation score of a player is calculated based on the raw rating value, and the evaluation score is presented to the player.

Specifically, the evaluation score to be presented to the player is calculated using the following formula.

$$Evaluation score = RawRate \times reflection ratio \times SCALE + OFFSET \qquad ( 1 )$$

Here, the “RawRate” is the raw rating value of the player calculated by the predetermined rating method. The “SCALE” is a constant. For example, the “SCALE” may be set to “3”. The “OFFSET” is a constant. For example, the OFFSET is set to “3000”.

The range of values that can be taken by the “RawRate” differs depending on the predetermined rating method. In the predetermined rating method according to the exemplary embodiment, for example, the range of values that can be taken by the “RawRate” is 500 to 3500. For example, the initial value of the RawRate is set to “1500”.

The “reflection ratio” is a value indicating a ratio regarding how close to the “RawRate” the evaluation score to be presented to the player is to be brought. For example, the “reflection ratio” is a value that changes from 0 to 1. The “reflection ratio” is set with respect to each player.

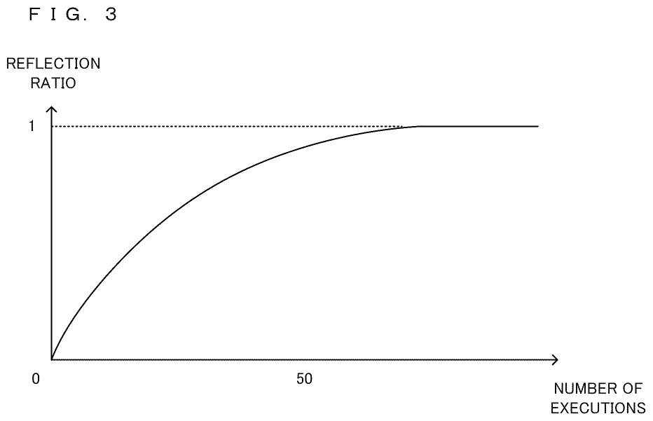

FIG. 3 is a diagram showing an example of the relationship between the “reflection ratio” and the number of executions of the game. FIG. 3 conceptually represents the relationship between the “reflection ratio” and the number of executions of the game. Actually, the “reflection ratio” fluctuates up and down in accordance with the execution result of the game.

The shape of a curve shown in FIG. 3 differs depending on the execution result of the racing game by the player. The more the player executes the multiplay racing game, the greater the value of the “reflection ratio” is. If the player executes the multiplay racing game a sufficient number of times, the value of the “reflection ratio” reaches “1”. The “reflection ratio” is likely to increase at first and gradually becomes less likely to increase. That is, while the number of executions of the game is small, the amount of increase in the reflection ratio according to a single execution of the game is relatively great. If the number of executions of the game is great, the amount of increase in the reflection ratio according to a single execution of the game is small. If the number of executions of the game exceeds a certain number of executions, the reflection ratio stops increasing. The higher the ranking of the player in the multiplay racing game is, the more likely the “reflection ratio” is to increase.

For example, the “reflection ratio” is calculated by the following formulas.

$$BD = MAX ( ( 1. - reflection ratio ) \times 0.1 , 0.0001 ) \qquad ( 2 )$$

$$D = BD \times ( the number of participants in the race - Rank - 0.5 ) the number of participants in the race \qquad ( 3 )$$

$$Reflection ratio = MIN ( reflection ratio + D , 1. ) \qquad ( 4 )$$

Here, MAX(A, B) is a function that outputs the greater of A and B. MIN(A, B) is a function that outputs the smaller of A and B.

“The number of participants in the race” is the number of players currently participating in the multiplay racing game. For example, the number of participants in the race is a value in the range of 2 to 24. If participating objects that perform the multiplay racing game include non-player objects, the number of player objects except for the non-player objects is “the number of participants in the race”.

The “Rank” is a value indicating the ranking of the player in the current multiplay racing game, and for example, is a value in the range of 0 to 23. If the ranking of the player is the first place, the value of the Rank is “0”. If the ranking of the player is the 24th place, the value of the Rank is “23”. If participating objects that perform the multiplay racing game include non-player objects, the rankings of player objects except for the non-player objects are the “Rank”.

For example, if the first racing game is performed, the initial value of the “reflection ratio” is “0”, and therefore, “BD” is “0.1”. If the first racing game is performed by 24 players, and the ranking of a player A is the first place, D=0.1×23.5/24. Thus, the value of the “reflection ratio” of the player A after the first racing game ends is “0.1×23.5/24”. On the other hand, in this racing game, if the ranking of a player B is the twentieth place, D=0.1×(24−19−0.5)/24. Thus, the value of the “reflection ratio” of the player B after the first racing game ends is “0.1×4.5/24”. If the first racing game is performed, the RawRate of each player is also updated. For example, as the RawRate of the player A after the first racing game is performed, a value (e.g., “100”) according to the ranking in the first racing game is added to the initial value “1500”. As the RawRate of the player B after the first racing game is performed, a value (e.g., “−50”) according to the ranking in the first racing game is added to the initial value “1500”. In this case, the evaluation score of the player A after the first racing game is 1600×0.1×23.5/24×3+3000=3470. The evaluation score of the player B after the first racing game is 1450×0.1×4.5/24×3+3000=3081 (decimals are rounded down).

If the OFFSET is not added in the above formula (1), the evaluation score of the player A after the first racing game is “470”, and the evaluation score of the player B after the first racing game is “81”. In this case, the displayed ability of the player A is more than five times the ability of the player B. That is, if the “OFFSET” is not added, there is a case where the initial value of the evaluation score is too small. Even if the difference in ability between the players is actually not very great, there is a possibility that the abilities of the players seem greatly different from each other, and the players lose a sense of scale. Thus, in the exemplary embodiment, a value obtained by adding the “OFFSET” to a value based on the multiplication of the “RawRate” and the “reflection ratio” is calculated as the evaluation score. Consequently, it is possible to prevent the evaluation score of the player from being too small while the racing game is not executed a sufficient number of times.

In the formulas (2) to (4), the higher the ranking in the racing game is, the greater “D” is. Additionally, “D” takes a positive value. Thus, the greater the number of executions of the game is, the greater the “reflection ratio” is. The greater the “reflection ratio” is, the smaller BD is. Thus, while the number of executions of the game is small, the range of increase in the “reflection ratio” is great. If the number of executions increases, the range of increase gradually becomes small.

If the player loses the game (has a low ranking), the “RawRate” decreases. However, if the number of executions of the game is not sufficient, the influence of an increase in the “reflection ratio” is great, and the amount of decrease in the “RawRate” is reduced by an increase in the “reflection ratio”. Thus, until the number of executions of the game reaches a certain number of executions, the more the player executes the racing game, the more likely the evaluation score is to often increase.

If the player performs the multiplay racing game a sufficient number of times, the “reflection ratio” reaches “1.0”. In this state, the evaluation score is the linear transformation of the RawRate, and the ability of the player calculated by the predetermined rating method is reflected as it is.

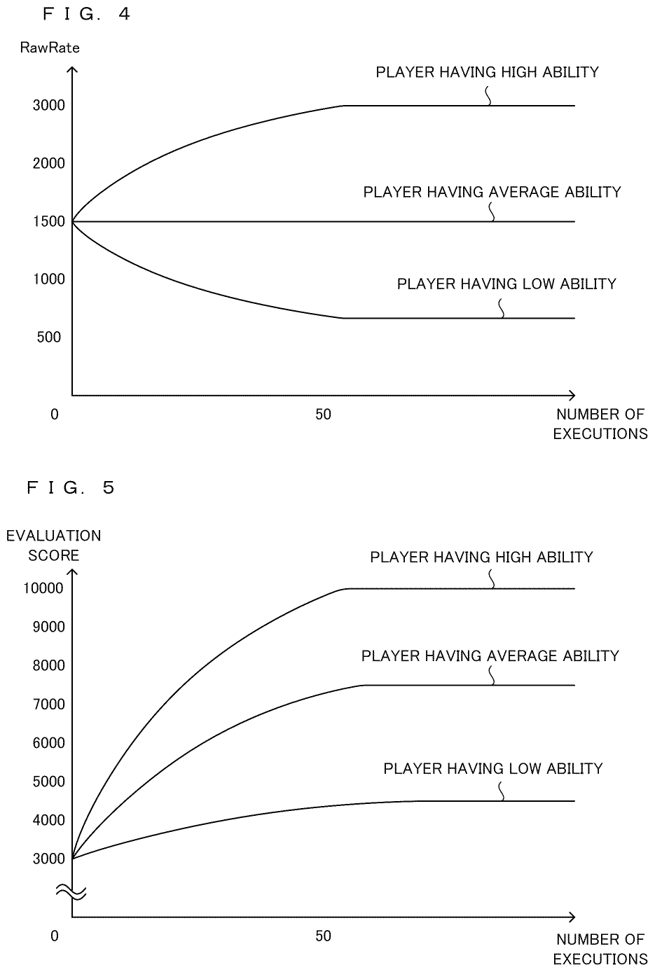

FIG. 4 is a diagram showing examples of the relationships between the RawRate of players that differ in ability and the number of executions of the game. FIG. 5 is a diagram showing examples of the relationships between the evaluation scores of the players that differ in ability and the number of executions of the game. FIG. 4 conceptually represents the relationships between the RawRate of the players and the number of executions of the game. Actually, the RawRate fluctuates up and down in accordance with the execution result of the game. Similarly, FIG. 5 conceptually represents the relationships between the evaluation scores of the players and the number of executions of the game. Actually, the evaluation scores fluctuate up and down in accordance with the execution result of the game.

As shown in FIG. 4, the RawRate of a player having a high ability increases in accordance with the number of executions of the game. If the number of executions becomes sufficient, the RawRate of the player converges to a certain value. The RawRate of a player having an average ability hardly changes in accordance with the number of executions of the game. On the other hand, the RawRate of a player having a low ability decreases in accordance with the number of executions of the game. If the number of executions becomes sufficient, the RawRate of the player converges to a certain value.

On the other hand, as shown in FIG. 5, the more any player executes the game, the higher the evaluation score is. The evaluation score of the player having a low ability gradually increases in accordance with the number of executions of the game. If the number of executions becomes sufficient, the evaluation score of the player converges to a certain value. The evaluation score of the player having a low ability increases for a long period. On the other hand, the evaluation score of the player having a high ability relatively rapidly increases in accordance with the number of executions of the game. If the number of executions becomes sufficient, the evaluation score of the player converges to a certain value. The evaluation score of the player having a high ability converges to a value according to the ability sooner.

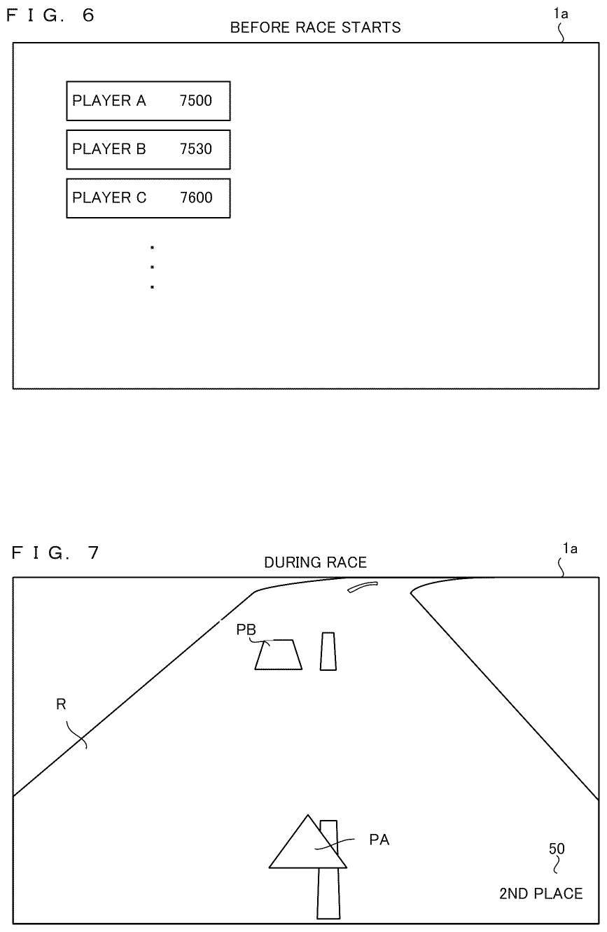

The evaluation scores of the players are displayed before the multiplay racing game starts. FIG. 6 is a diagram showing an example of a game image displayed on a screen of a game system 1a corresponding to the player A before the multiplay racing game starts. For example, if the racing game is performed by a plurality of players including the player A, the player B, and the player C, the evaluation scores of the players before the racing game starts are displayed on a screen of the game system 1 of each player. For example, the evaluation score of the player A before the racing game starts is “7500”. The evaluation score of the player B before the racing game starts is “7530”. The evaluation score of the player C before the racing game starts is “7600”.

Specifically, the game system 1a transmits a participation request to the server in accordance with a start instruction to start the multiplay racing game given by the player A. The same applies to game systems 1b and 1c corresponding to the players B and C. The server stores information identifying each player and the RawRate of each player in association with each other. If the server receives the participation request, the server matches a plurality of players having close abilities based on the RawRate of each player. For example, suppose that the server matches a plurality of players including the players A to C. In this case, the server transmits the RawRate of each player to the game systems 1a to 1c of the players A to C. The server also transmits information including a session ID to the game systems 1a to 1c. Based on the session ID received from the server, the game systems 1a to 1c establish communication with each other. Then, the game systems 1a to 1c exchange information regarding the players. For example, the information regarding the players is information regarding the external appearances and the shapes of the player objects, player names, the values of the “reflection ratio”, and the like. Each game system 1 may receive the RawRate of the other players from the server, or may receive the RawRate of the other players from the other game systems 1.

Based on the received “reflection ratio” and “RawRate”, each game system 1 calculates the evaluation scores of the players. Then, each game system 1 displays the evaluation scores of the players before the racing game starts.

FIG. 7 is a diagram showing an example of an image displayed on the screen of the game system 1a and is a diagram showing an example of a game image displayed during the execution of the multiplay racing game. As shown in FIG. 7, a player object PA corresponding to the player A is running on a route R. In front of the player object PA, a player object PB corresponding to the player B is running. Although not shown in the figures, other player objects participating in this racing game are also present behind the player object PA. At the lower right of the screen, ranking display 50 indicating the current ranking of the player object PA is displayed. The ranking display 50 indicates that the player object PA is currently in the second place.

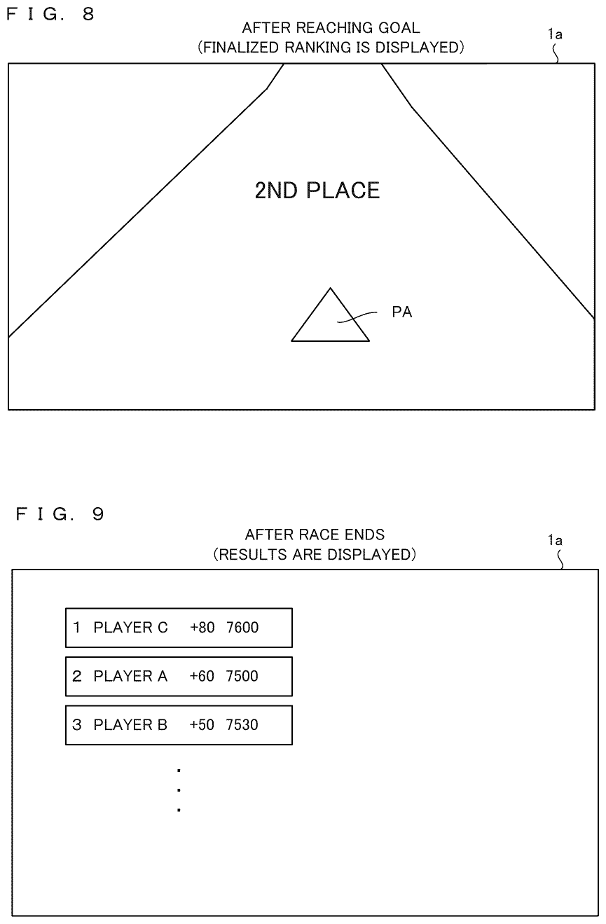

FIG. 8 is a diagram showing an example of a game image displayed when the player object PA reaches a goal, and the ranking of the player object PA is displayed. If the player object PA passes through a goal point set on a course, the ranking of the player object PA is displayed.

Here, the determination of the ranking of each player object is described. During a racing game, based on operation data from the controllers, the game system 1 updates the position of the player object corresponding to the game system 1. During the racing game, the game system 1 receives information regarding the position, the speed, and the moving direction of another player object corresponding to another game system 1 from the other game system 1 and updates the position of the other player object based on the received information. Based on the positions of the player object and the other player object updated by the game system 1, the game system 1 determines whether or not the player object and the other player object reach the goal. If the game system 1 determines that the player object and the other player object reach the goal, the game system 1 determines the rankings of the player object and the other player object. Then, the game system 1 transmits provisional ranking information indicating the determined rankings to the server.

The server finalizes the rankings in order from the first place based on the provisional ranking information from the game system 1. Specifically, the server finalizes which of the player objects is in each ranking. For example, if the server receives provisional ranking information indicating the first place from a plurality of game systems 1, the server finalizes which of the player objects is in the first place based on information regarding the player objects included in the provisional ranking information from each game system 1. For example, if the server determines that a majority of game systems 1 indicate that the player object PA is in the first place, the server finalizes that the player object PA is in the first place. If a majority is not reached, the server finalizes a player object in the first place by majority vote. The server may finalize the ranking of each player object based on provisional ranking information from each game system 1. For example, if the server receives the “second place” from a majority of game systems 1 as provisional ranking information regarding the player object PA, the server may finalize that the ranking of the player object PA is the “second place”. The server also updates the RawRate of the player based on the finalized ranking. Then, the server transmits information including the updated RawRate and the finalized ranking of the player to each game system 1.

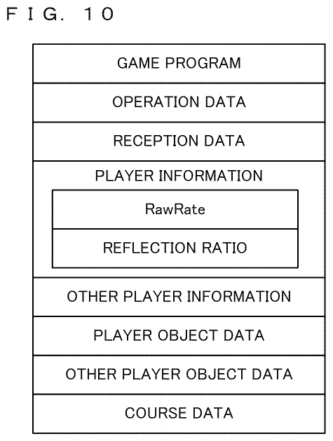

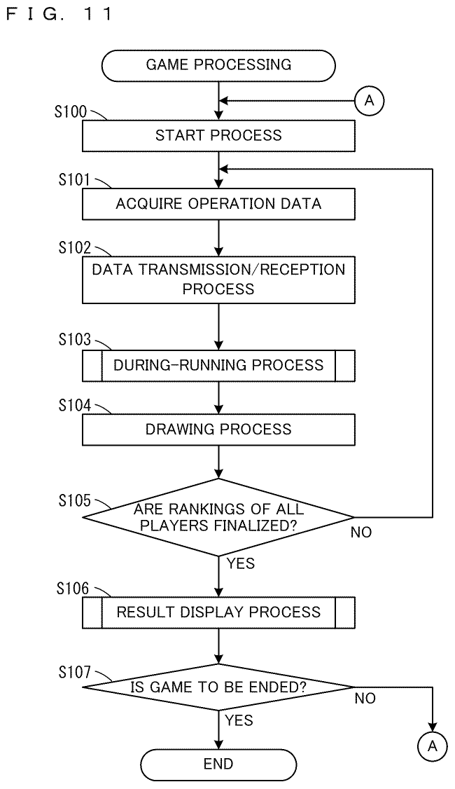

FIG. 9 is a diagram showing an example of an image displayed on the screen of the game system 1a and is a diagram showing an example of a result display image displayed after the multiplay racing game ends.

If all the player objects participating in the racing game reach the goal point, the server finalizes the rankings of all the player objects. Then, as shown in FIG. 9, result display including the rankings and the evaluation scores of all the players participating in the racing game is displayed. Specifically, as the result display, the evaluation scores of the players before the race starts and values to be added in the current racing game are displayed. For example, the player C is in the first place in the current racing game, and the evaluation score “7600” before the race starts and the value “80” to be added in the current racing game are displayed. After the game image shown in FIG. 9, the evaluation scores after the addition are displayed. For example, “7680” is displayed as the evaluation score of the player C after the current racing game.

More specifically, based on the value of the “reflection ratio” of each player received before the current racing game starts and the finalized ranking and the “RawRate” of each player in the current racing game, the game system 1a calculates the evaluation scores of the players. Then, the game system 1a displays the result display shown in FIG. 9.

As described above, in the exemplary embodiment, the “RawRate” based on the predetermined rating method and the “reflection ratio” that increases in accordance with the number of executions of the racing game are acquired, the evaluation score of a player is calculated based on a value obtained by reflecting the “RawRate” to a degree indicated by the “reflection ratio” (the RawRate×the reflection ratio), and the calculated evaluation score is presented to the player. Consequently, it is possible to reduce the possibility that the motivation of the player decreases, and it is also possible to present the RawRate reflecting the ability of the player with an increase in the number of executions of the game.

### Details of Processing

Next, a description is given of the details of processing of the game system 1 and the server for presenting the above evaluation score to the player. Here, processing performed by the game system 1a corresponding to the player PA is described. First, data stored in the game system 1a is described.

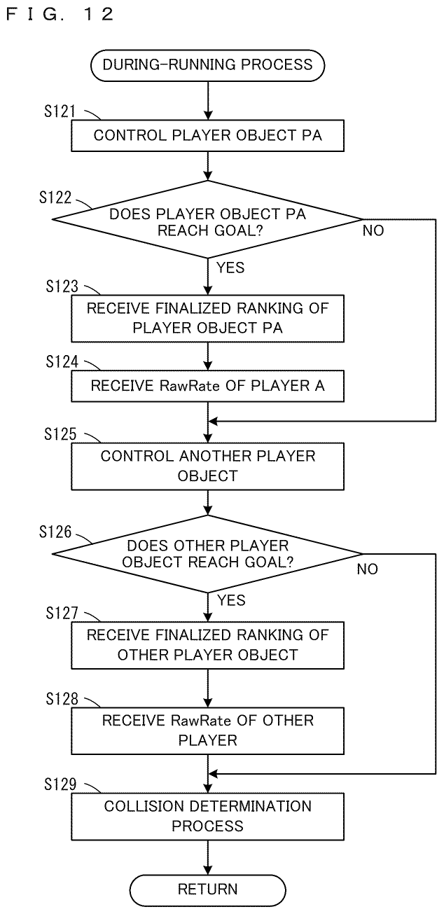

FIG. 10 is a diagram showing examples of various pieces of data stored in the game system 1. As shown in FIG. 10, for example, a memory (e.g., the DRAM 27, a storage medium attached to the slot 29, or the flash memory 26) of the game system 1a stores a game program, operation data, reception data, player information, other player information, player object data, other player object data, and course data.

The game program is a program for executing processes related to the game according to the exemplary embodiment (processes shown in FIGS. 11 to 13 described below). For example, the game program is stored in advance in the storage medium attached to the slot 29 or the flash memory 26 and is loaded into the DRAM 27 when a racing game is executed.

The operation data is data corresponding to operations on the controllers 3 and 4 of the game system 1a. The operation data is acquired at predetermined time intervals (e.g., 1/200-second intervals) from the controllers 3 and 4.

The reception data is data received from another game system 1 during the same racing game. The reception data includes data regarding each of a plurality of other player objects. Specifically, the reception data includes data regarding the position, the orientation, the moving direction, the speed, and the like of each of the other player objects. For example, the reception data is received from another game system 1 at predetermined time intervals. The frequency of the reception of the reception data from another game system 1 is lower than the frequency of the reception of the operation data from the controllers.

The player information is information regarding the player A and includes the “RawRate” and the “reflection ratio” of the player A. The “RawRate” of the player A is calculated by the server and received from the server. The “reflection ratio” of the player A is calculated by the game system 1a and stored in the game system 1a.

The other player information is information regarding another player participating in the racing game and includes the “RawRate” and the “reflection ratio” of the other player. The “RawRate” of the other player is received from the server or the other game system 1. The “reflection ratio” of the other player is received from the other game system 1.

The player object data is data regarding the player object PA operated by the player A. For example, the player object data includes data indicating the shape and the external appearance of the player object PA, and data indicating the position, the orientation, the moving direction, the speed, and the like of the player object PA.

The other player object data includes data regarding another player object operated by another player. The other player object data includes data regarding each of the plurality of other player objects. Specifically, the other player object data includes data indicating the shape and the external appearance of each of the other player objects, and data indicating the position, the orientation, the moving direction, the speed, and the like of each of the other player objects.

The course data is data that defines a course where a racing game in each section is performed. For example, the course data includes data indicating a region including a starting point to a goal point where the player object and another player object move. For example, the course data is stored in advance in the game system 1.

The game system 1 also stores various pieces of data in addition to the data shown in FIG. 10.

### Game Processing

Next, game processing performed by the game system 1 is described. FIG. 11 is a flow chart showing an example of the game processing performed by the game system 1. For example, the game processing shown in FIG. 11 is executed if the multiplay racing game is selected by the player on a game selection screen.

In the exemplary embodiment, the description is given on the assumption that the processes of steps shown in FIGS. 11 to 13 are executed by the processor 21 of the main body apparatus 2 executing the game program using a memory (e.g., the DRAM 27). In another exemplary embodiment, however, some of the processes of the steps may be executed by a processor (e.g., a dedicated circuit or the like) different from the processor 21. Some of the processes of the steps may be executed by another information processing apparatus (e.g., a server). The processes of all of the steps are merely illustrative. Thus, the processing order of the steps may be changed, or another process may be performed in addition to (or instead of) the processes of all of the steps, so long as similar results are obtained.

As shown in FIG. 11, first, the processor 21 performs a start process (step S100). Specifically, the processor 21 transmits a participation request to participate in the multiplay racing game to the server on the Internet. For example, the participation request includes information identifying the game system 1a and information regarding the player A (e.g., information identifying the player A, the player name, and the like). After the processor 21 transmits the participation request, the processor 21 waits to receive a response from the server. For example, the response from the server includes the RawRate of the player A, information regarding another player matched with the player A, and a session ID for the game system 1a to communicate with the other game system 1 corresponding to the other player. For example, the information regarding the other player includes information identifying the other player, the player name, and the like. If the processor 21 receives a response from the server, based on a session ID included in the response, the processor 21 establishes communication with the other game systems 1 corresponding to other players participating in the racing game. If the processor 21 establishes communication with the other game systems 1, the processor 21 exchanges information required to execute the racing game. For example, the processor 21 transmits player information including the “RawRate” of the player A and the “reflection ratio” of the player A to the other game systems 1. The processor 21 also receives other player information including the “RawRate” of the player B and the “reflection ratio” of the player B from the game system 1b corresponding to the player B. The processor 21 also receives other player information including the “RawRate” of the player C and the “reflection ratio” of the player C from the game system 1c corresponding to the player C. The processor 21 also receives information regarding (e.g., information indicating the shapes and the external appearances of) the other player objects PB and PC and transmits information regarding the player object PA. The processor 21 also sets a course where the racing game is to be performed, and places the plurality of participating objects including the player objects PA to PC at a starting point of the course. Then, if a condition for starting the racing game is satisfied, the processor 21 starts the racing game and ends the start process in step S100. In the start process, the processor 21 may receive the RawRate of the other players from the server.

Next, the processor 21 acquires operation data (step S101). The main body apparatus 2 repeatedly acquires operation data from the controllers 3 and 4 at predetermined time intervals (e.g., 1/200-second intervals) and stores the operation data in a memory. In step S101, the processor 21 acquires the operation data stored in the memory.

Next, the processor 21 performs a data transmission/reception process (step S102). Here, as the data reception process, the processor 21 acquires reception data from the game systems 1b and 1c. For example, the processor 21 receives data regarding the positions, the orientations, the moving directions, the speeds, and the like of the other player objects PB and PC as the reception data from the game systems 1b and 1c. As the data transmission process, the processor 21 transmits data regarding the position, the orientation, the moving direction, the speed, and the like of the player object PA to the game systems 1b and 1c.

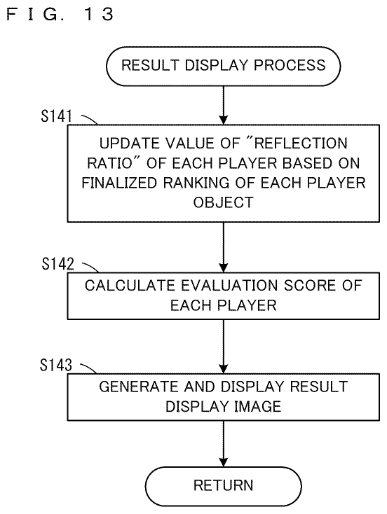

Next, the processor 21 performs a during-running process (step S103). The details of the during-running process in step S103 are described below. FIG. 12 is a flow chart showing the details of the during-running process in step S103.

### During-Running Process

As shown in FIG. 12, based on the operation data, the processor 21 controls the player object PA (step S121). For example, if a predetermined button (e.g., the A-button) of the controller 4 is pressed, the processor 21 moves the player object PA forward by a predetermined distance and updates the position of the player object PA. In accordance with an input direction of the analog stick of the controller 3, the processor 21 also controls the direction (the moving direction) of the player object PA. Based on the operation data, the processor 21 also causes the player object PA to jump in the virtual space or perform a predetermined action in the virtual space.

Next, based on the updated position of the player object PA, the processor 21 determines whether or not the player object PA reaches a goal point (step S122).

If it is determined that the player object PA reaches the goal point (step S122: YES), the processor 21 receives the finalized ranking of the player object PA (step S123). Specifically, the processor 21 transmits provisional ranking information indicating the ranking of the player object PA determined by the processor 21 to the server and receives the finalized ranking of the player object PA from the server. If the finalized ranking of the player object PA is received, the processor 21 generates an image indicating the finalized ranking of the player object PA. Consequently, the game image shown in FIG. 8 is displayed. After the rankings of all the player objects are finalized, the finalized rankings may be displayed.

After the player object PA reaches the goal point, in step S121, the processor 21 may automatically control the player object PA, or may control the player object PA based on the operation data.

After step S123, the processor 21 receives the RawRate of the player A from the server (step S124). Here, the processor 21 receives the RawRate of the player A updated by the server based on the finalized ranking of the player object PA.

If the process of step S124 is executed, or if the determination is NO in step S122, the processor 21 controls another player object based on the reception data (step S125). For example, based on the speed and the moving direction of the other player object, the processor 21 updates the position of the other player object. Based on the reception data, the processor 21 also causes the other player object to jump in the virtual space or perform a predetermined action in the virtual space.

Next, based on the updated position of the other player object, the processor 21 determines whether or not the other player object reaches the goal point (step S126).

If it is determined that the other player object reaches the goal point (step S126: YES), the processor 21 receives the finalized ranking of the other player object from the server (step S127). Specifically, the processor 21 transmits provisional ranking information indicating the ranking of the other player object determined by the processor 21 to the server and receives the finalized ranking of the other player object from the server.

After the other player object reaches the goal point, in step S125, the processor 21 may automatically control the other player object, or may control the other player object based on the reception data.

After step S127, the processor 21 receives the RawRate of the other player (step S128). Here, the processor 21 receives the RawRate of the other player updated by the server based on the finalized ranking of the other player object.

If the process of step S128 is executed, or if the determination is NO in step S126, the processor 21 performs a collision determination process (step S129). Here, a collision determination (a contact determination) between various objects placed in the virtual space and each player object is made, and a process corresponding to the result of the determination is performed. For example, the processor 21 makes a collision determination between the player object PA and the other player object. If it is determined that the player object PA and the other player object collide with each other, the processor 21 overturns, decelerates, or temporarily stops the player object PA and/or the other player object. The processor 21 also makes a collision determination between the player object PA and another object and performs a process corresponding to the result of the collision determination. The processor 21 also makes a collision determination between the other player object and another object and performs a process corresponding to the result of the collision determination. For example, the other object may be a wall object fixed to the virtual space, or may be an object that moves in the virtual space (e.g., an obstacle object or an item discharged from a player object, or the like).

If the process of step S129 is executed, the processor 21 ends the process shown in FIG. 12, and the processing returns to FIG. 11.

After the process of step S103, the processor 21 performs a drawing process (step S104). Here, the processor 21 generates a game image based on the virtual camera following the player object PA. Consequently, a game image corresponding to the results of the processes of the above steps S101 to S103 is generated and displayed on the screen of the game system 1a.

Next, the processor 21 determines whether or not the rankings of all the players are finalized (step S105).

If the rankings of all the players are not finalized (step S105: NO), the processor 21 executes the process of step S101 again. The processor 21 repeatedly executes the processes of steps S101 to S105 at predetermined frame time intervals (e.g., 1/60-second intervals). Consequently, the racing game progresses. The data transmission/reception process in step S102 may be executed at several frame time intervals.

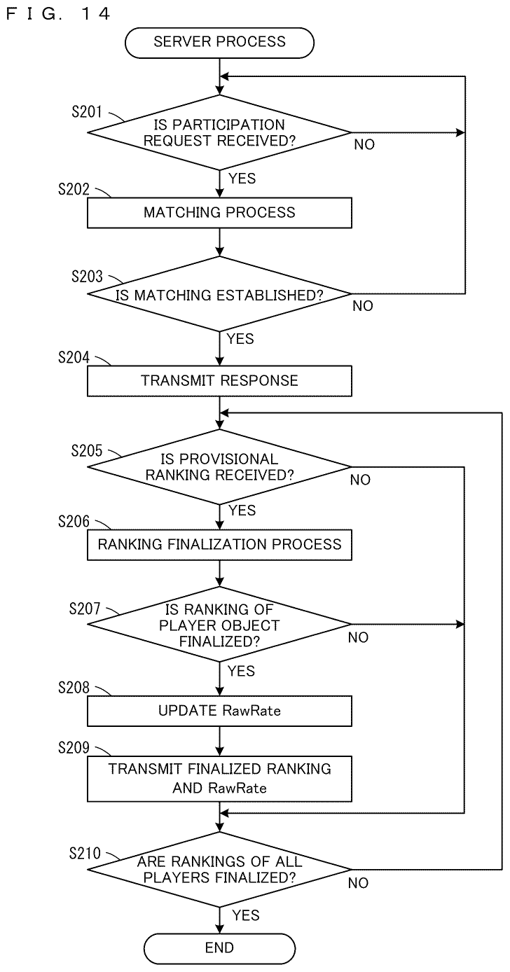

If the rankings of all the players are finalized (step S105: YES), the processor 21 performs a result display process (step S106). The details of the result display process in step S106 are described below. FIG. 13 is a flow chart showing the details of the result display process in step S106.

### Result Display Process

As shown in FIG. 13, the processor 21 updates the value of the “reflection ratio” of each player based on the finalized ranking of each player object (step S141). Here, the processor 21 updates the value of the “reflection ratio” of the player A based on the finalized ranking of the player object PA. Specifically, the processor 21 updates the value of the reflection ratio of the player A based on the finalized ranking of the player object PA and the number of participants in the race. The processor 21 also updates the value of the “reflection ratio” of another player based on the “reflection ratio” of the other player received before the race starts in step S100, the finalized ranking of the other player, and the number of participants in the race.

Next, the processor 21 calculates the evaluation score of each player (step S142). Specifically, the processor 21 calculates the evaluation score of the player A based on the “reflection ratio” of the player A updated in step S141 and the RawRate of the player A received from the server in step S124. The processor 21 also calculates the evaluation score of another player based on the “reflection ratio” of the other player updated in step S141 and the RawRate of the other player received from the server in step S128.

Next, the processor 21 generates a result display image based on the calculated evaluation scores of the players and displays the result display image on the screen of the game system 1a (step S143). Consequently, a result display image as shown in FIG. 9 is displayed. If the process of step S143 is executed, the processor 21 ends the process shown in FIG. 13, and the processing returns to FIG. 11.

Referring back to FIG. 11, if the process of step S106 is executed, the processor 21 determines whether or not to end the multiplay racing game (step S107). For example, the processor 21 determines whether or not the player gives an instruction to end the multiplay racing game. If it is determined that the multiplay racing game is to be ended (step S107: YES), the processor 21 ends the processing shown in FIG. 11. If it is determined that the multiplay racing game is not to be ended (step S107: NO), the processor 21 executes the process of step S100 again.

### Server Process

Next, a process performed by the server is described. FIG. 14 is a flow chart showing an example of the server process performed by the server.

As shown in FIG. 14, the server determines whether or not a participation request to participate in the multiplay racing game is received from the game system 1 (step S201). If a participation request is received (step S201: YES), the server performs a matching process for matching a plurality of players (step S202). The server stores the value of the RawRate of each player. For example, based on the RawRate of the player having transmitted the participation request, the server matches a plurality of players. For example, the server matches players having close RawRate.

After step S202, the server determines whether or not matching between the plurality of players is established (step S203). For example, if the number of matched players reaches an upper limit (e.g., 24), the determination of the server is YES in step S203. If the number of matched players does not reach the upper limit at the time when a predetermined timeout time elapses, the server establishes matching between the plurality of players matched at this time. If the number of matched players does not satisfy a predetermined number (e.g., 1), the server transmits information indicating that matching is not established to the game system 1.

If the determination is NO in step S201, or if the determination is NO in step S203, the server executes the process of step S201 again.

If it is determined that matching is established (step S203: YES), the server transmits a response to the participation request to each game system 1 (step S204). Here, the response includes a session ID for the game systems 1 to communicate with each other. The response also includes the RawRate of the player corresponding to each game system 1. Based on the session ID, the game systems 1 establish communication with each other. Then, the multiplay racing game is performed by the game systems 1.

Next, the server determines whether or not provisional ranking information is received from the game system 1 (step S205).

If provisional ranking information is received (step S205: YES), the server performs a ranking finalization process (step S206). Here, the server totalizes provisional ranking information from the plurality of game systems 1 participating in the racing game and finalizes the ranking of the player object. Specifically, if a majority of game systems determine the same ranking regarding a certain player object, the server finalizes the ranking of the player object. In a case where the provisional ranking information from all the game systems 1 participating in the racing game is received, and if a majority is not reached, the server finalizes the ranking of the player object by majority vote.

Next, based on the result of the ranking finalization process, the server determines whether or not the ranking of the player object is finalized (step S207).

If the ranking of the player object is finalized (step S207: YES), the server updates the RawRate of the player, the ranking of which is finalized (step S208). For example, the server updates the RawRate of the player by the predetermined rating method based on the finalized ranking of the player and the number of participants in the race.

Next, the server transmits information including the finalized ranking of the player and the updated RawRate of the player to each game system 1 (step S209).

If the process of step S209 is executed, or if the determination is NO in step S205, or if the determination is NO in step S207, the server determines whether or not the rankings of all the players participating in the racing game are finalized (step S210).

If the rankings of all the players are not finalized (step S210: NO), the server executes the process of step S205 again.

If the rankings of all the players are finalized (step S210: NO), the server ends the process shown in FIG. 14.

As described above, in the exemplary embodiment, a player performs a competition (e.g., a racing game) with another player in a multiplay game (steps S101 to S105). A first parameter (e.g., the RawRate) that increases or decreases based on the result of the competition and a second parameter (e.g., the reflection ratio) that increases from the minimum value to the maximum value in accordance with an increase in the number of competitions in the multiplay game are acquired (steps S124 and S128). At least based on a third parameter reflecting the first parameter to a degree indicated by the second parameter (e.g., the RawRate ×the reflection ratio), the evaluation score of the player is calculated (e.g., step S142). Then, the calculated evaluation score is presented to the player (step S143).

Since the second parameter increases in accordance with an increase in the number of competitions, the third parameter reflecting the first parameter to a degree indicated by the second parameter comes close to the first parameter in accordance with an increase in the number of competitions. In a case where the first parameter is directly presented to the player, the first parameter may decrease in accordance with the result of a competition, but in the method according to the exemplary embodiment, the evaluation score comes close to the first parameter while gradually increasing in accordance with an increase in the number of competitions. Consequently, for example, also in a case where the first parameter decreases in accordance with the result of a competition, it is possible to make the evaluation score to be presented to the player less likely to decrease, and it is possible to reduce the possibility that the motivation of the player decreases even if the player loses a competition.

The third parameter may be such a value that the greater the second parameter is, the closer to the first parameter the value is. For example, the third parameter may be a value based on the multiplication of the first and second parameters.

In the exemplary embodiment, the greater the number of competitions is, the smaller the amount of increase in the second parameter with respect to each competition is. Consequently, while the number of competitions is small, it is possible to make the influence of an increase in the second parameter great. For example, the more the player performs a competition, the higher the evaluation score can be. Even if the player loses a competition, it is possible to make the influence of the first parameter that decreases by losing small. If the number of competitions is great, it is possible to make the influence of the first parameter great. It is possible to bring the evaluation score close to the ability of the player.

In the exemplary embodiment, the higher the ranking in a competition is, the greater the amount of increase in the second parameter according to an increase in the number of competitions by the competition is. Consequently, for example, it is possible to reflect the first parameter on the evaluation score of a player having a high ability.

In the exemplary embodiment, the evaluation score is calculated by adding a predetermined offset to the third parameter. Consequently, it is possible to prevent the evaluation score of the player from being too low.

In the exemplary embodiment, the first parameter is managed by the server and is acquired from the server after a competition. Consequently, for example, it is possible to acquire the first parameter reflecting the result of a competition from the server. For example, it is possible to prevent dishonesty.

In the exemplary embodiment, the player performs a competition with another player based on the first parameter. Consequently, for example, it is possible to use the first parameter reflecting the result of the competition to determine an opponent, while it is possible to present the evaluation score obtained by adjusting the result of the competition to the player.

In the exemplary embodiment, when a competition in a multiplay game starts, the game system 1 acquires the second parameter of another player before the competition and acquires the first parameter of the other player based on the result of the competition from the server after the competition ends. Then, the game system 1 updates the second parameter of the other player based on the second parameter acquired when the competition starts and the result of the competition, and calculates the evaluation score of the other player after the competition based on the updated second parameter and the first parameter acquired from the server after the competition ends. Consequently, it is possible to calculate the evaluation score of another player without acquiring the evaluation score from the other player. For example, it is possible to present the evaluation score of the other player to the player immediately after the competition.

### Variations

While the exemplary embodiment has been described above, the exemplary embodiment is merely an example and may be modified as follows, for example.

For example, in the above exemplary embodiment, the reflection ratio is a value indicating the degree to which the evaluation score is brought close to the RawRate, and increases from 0 to 1. In another exemplary embodiment, the maximum value of the reflection ratio is not limited to 1, and may be any value. The minimum value of the reflection ratio is not limited to 0, and may be any value.

In the above exemplary embodiment, the evaluation score is calculated by calculating the multiplication of the RawRate, the reflection ratio, and the SCALE. The calculation method for calculating the evaluation score is merely an example, and may be another method. In another exemplary embodiment, the evaluation score may be calculated by calculating a value based on the multiplication of the RawRate and the reflection ratio.

At least a part of the processing performed by the above game system 1 may be executed by the server. At least a part of the processing performed by the server may be performed by the game system 1. For example, in another exemplary embodiment, the server may calculate and save the RawRate and the reflection ratio. The server may calculate the evaluation score. The game system 1 may calculate and save the RawRate. The game system may acquire (calculate and acquire or acquire from the server) the RawRate, acquire (calculate and acquire or acquire from the server) the reflection ratio, and calculate the evaluation score based on a parameter reflecting the “RawRate” to a degree indicated by the “reflection ratio”.

In another exemplary embodiment, a plurality of types of multiplay games can be executed. The evaluation score of a player regarding each of the multiplay games may be calculated and presented to the player.

In the above exemplary embodiment, the game systems 1 establish communication with each other based on the session ID, exchange the reflection ratio before the racing game starts, and exchange position information regarding the player objects and the like during the execution of the racing game. That is, the exchange of information with the other players during the racing game and the exchange of information with the other players before the racing game starts are performed based on P2P communication between the game systems. In another exemplary embodiment, the game systems 1 may exchange information with the other game systems 1 via the server. For example, the game systems 1 may exchange the reflection ratios via the server before the racing game starts. The game systems 1 may exchange position information regarding the player objects and the like via the server during the execution of the racing game.

In the above exemplary embodiment, the game system 1 performs movement control of a player object. In another exemplary embodiment, the server may perform movement control of a player object. That is, the server may perform movement control of player objects and transmit position information regarding the player objects to the game systems 1, and the game systems 1 may display the player objects.

In the above exemplary embodiment, a plurality of game systems 1 and the server are connected together via the Internet, and a multiplay game is performed using the plurality of game systems 1 and the server. In another exemplary embodiment, at least any one of the plurality of game systems 1 may function as the above server.

The above processing may be executed not only by the game system 1, but also by any other information processing apparatus or information processing system.

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors to perform operations comprising:
causing a player to perform a competition with another player in a multiplay game based on game processing;
calculating an evaluation score for the player at least based on a third parameter obtained by reflecting a first parameter that increases or decreases based on a result of the competition to a degree indicated by a second parameter that increases from a minimum value to a maximum value in accordance with an increase in the number of competitions in the multiplay game; and
presenting the evaluation score.

2. The one or more non-transitory computer-readable media according to claim 1, wherein
the first parameter is a value greater than or equal to 0,
the second parameter is a value greater than or equal to 0, and
the third parameter is a value based on a multiplication of the first and second parameters.

3. The one or more non-transitory computer-readable media according to claim 2, wherein
the greater the number of competitions is, the smaller an amount of increase in the second parameter with respect to each competition is.

4. The one or more non-transitory computer-readable media according to claim 2, wherein
the higher a ranking in the competition is, the greater an amount of increase in the second parameter by the competition according to the increase in the number of competitions is.

5. The one or more non-transitory computer-readable media according to claim 2, wherein
the operations further comprise calculating the evaluation score by further adding a predetermined offset to the third parameter.

6. The one or more non-transitory computer-readable media according to claim 1, wherein
the first parameter between the first and second parameters is acquired from a server after the competition.

7. The one or more non-transitory computer-readable media according to claim 1, wherein
the operations further comprise causing the player to perform the competition in the multiplay game with the other player determined based on the first parameter.

8. The one or more non-transitory computer-readable media according to claim 4, wherein
the operations further comprise:
when the competition in the multiplay game starts, at least acquiring the second parameter of the other player before the competition;
after the competition in the multiplay game ends, acquiring the first parameter of the other player based on the result of the competition from a server; and
updating the second parameter of the other player based on the second parameter acquired when the competition starts and the result of the competition, calculating an evaluation score of the other player after the competition based on the updated second parameter and the first parameter acquired from the server, and presenting the evaluation score.

9. An information processing system including a plurality of terminal apparatuses and a server, the information processing system comprising one or more processors that perform operations comprising:
causing a player to perform a competition with another player in a multiplay game based on game processing;
calculating an evaluation score for the player at least based on a third parameter obtained by reflecting a first parameter that increases or decreases based on a result of the competition to a degree indicated by a second parameter that increases from a minimum value to a maximum value in accordance with an increase in the number of competitions in the multiplay game; and
presenting the evaluation score.

10. The information processing system according to claim 9, wherein
the first parameter is a value greater than or equal to 0,
the second parameter is a value greater than or equal to 0, and
the third parameter is a value based on a multiplication of the first and second parameters.

11. The information processing system according to claim 10, wherein
the greater the number of competitions is, the smaller an amount of increase in the second parameter with respect to each competition is.

12. The information processing system according to claim 10, wherein
the higher a ranking in the competition is, the greater an amount of increase in the second parameter by the competition according to the increase in the number of competitions is.

13. The information processing system according to claim 10, wherein
the operations further comprise calculating the evaluation score by further adding a predetermined offset to the third parameter.

14. The information processing system according to claim 9, wherein
the server is configured to:
store the first parameter of each player; and
update the first parameter based on the result of the competition, and
each of the plurality of terminal apparatuses is configured to:
acquire the first parameter between the first and second parameters from the server after the competition.

15. The information processing system according to claim 9, wherein
the server is configured to:
based on the first parameter of each player, determine a plurality of players to be included in the competition in the multiplay game, and
each of the plurality of terminal apparatuses is configured to:
cause the player to perform the competition in the multiplay game with the other player determined by the server.

16. The information processing system according to claim 12, wherein
the server is configured to:
store the first parameter of each player; and
update the first parameter based on the result of the competition, and
each of the plurality of terminal apparatuses is configured to:
when the competition in the multiplay game starts, at least acquire the second parameter of the other player before the competition;
after the competition in the multiplay game ends, acquire the first parameter of the other player from the server; and
update the second parameter of the other player based on the second parameter acquired when the competition starts and the result of the competition, calculate an evaluation score of the other player after the competition based on the updated second parameter and the first parameter acquired from the server, and present the evaluation score.

17. A computer-implemented method comprising:
causing a player to perform a competition with another player in a multiplay game based on game processing;
calculating an evaluation score for the player at least based on a third parameter obtained by reflecting a first parameter that increases or decreases based on a result of the competition to a degree indicated by a second parameter that increases from a minimum value to a maximum value in accordance with an increase in the number of competitions in the multiplay game; and
presenting the evaluation score.

18. The computer-implemented method according to claim 17, wherein
the first parameter is a value greater than or equal to 0,
the second parameter is a value greater than or equal to 0, and
the third parameter is a value based on a multiplication of the first and second parameters.

19. The computer-implemented method according to claim 18, wherein
the greater the number of competitions is, the smaller an amount of increase in the second parameter with respect to each competition is.

20. The computer-implemented method according to claim 18, wherein
the higher a ranking in the competition is, the greater an amount of increase in the second parameter by the competition according to the increase in the number of competitions is.

21. The computer-implemented method according to claim 18, further comprising calculating the evaluation score by further adding a predetermined offset to the third parameter.

22. The computer-implemented method according to claim 17, wherein
the first parameter between the first and second parameters is acquired from a server after the competition.

23. The computer-implemented method according to claim 17, further comprising causing the player to perform the competition in the multiplay game with the other player determined based on the first parameter.

24. The computer-implemented method according to claim 20, further comprising:
when the competition in the multiplay game starts, at least acquiring the second parameter of the other player before the competition;
after the competition in the multiplay game ends, acquiring the first parameter of the other player based on the result of the competition from a server; and
updating the second parameter of the other player based on the second parameter acquired when the competition starts and the result of the competition, calculating an evaluation score of the other player after the competition based on the updated second parameter and the first parameter acquired from the server, and presenting the evaluation score.
